(19) United States
(12) Patent Application Publication
(10) Pub. No.: US 2006/0202065 A1
(43) Pub. Date: Sep. 14, 2006

(54) Nozzle for vacuum packaging

(76) Inventor: Joon-Yeong Ahn, ANSAN-CITY (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/550,308

(22) PCT Filed: Aug. 22, 2003
(86) PCT No.: PCT/KR03/01699

§ 371 Date: Sep. 22, 2005

(30) Foreign Application Priority Data
Mar. 22, 2003 (KR) 20-2003-0008615

(51) Int. Cl. B05B 1/18

(52) U.S. Cl. 239/567; 239/548; 239/589

(57) ABSTRACT

Disclosed is a nozzle for vacuum sealing a plastic bag, the nozzle including: an embossing part formed on the peripheral surface of the nozzle, so that air discharging passages are formed on the peripheral surface of the nozzle; and a plurality of break lines formed at predetermined regular intervals on the outer peripheral surface of the nozzle, for cutting the nozzle to a predetermined length, wherein the nozzle is made of a heat sealable material, so that the nozzle cut by the break line is inserted into the plastic bag and heat sealed together with the plastic bag.

### TECHNICAL FIELD

The present invention relates to a nozzle for vacuum sealing a plastic bag where articles like foods for storage are placed that is inserted into the plastic bag to form air discharging passages, that is heat sealed together with the plastic bag, and that is provided with a plurality of break lines on the outer peripheral surface thereof.

### BACKGROUND ART

Generally, plastic bags in which foods for storage are placed are vacuumed and sealed by a vacuum sealing apparatus, in order to keep the foods fresh.

As one of the prior arts, there is disclosed Korean Patent Laid-open Publication No. 92-0700998 entitled ‘An apparatus for vacuum sealing plastic bags’, which is illustrated in FIG. 1a. The conventional plastic bag 21 is provided with an embossing part 25 that is formed on the inner surface thereof in order to serve as air discharging passages at the time of sealing the plastic bag. The plastic bag 21 is vacuumed and heat sealed by using the apparatus 20 as shown in FIG. 1b.

In more detail, the conventional apparatus 20 for vacuum sealing the plastic bag 21 includes a base 32, a hood 33, a vacuum chamber 34 that is located between the base 32 and the hood 33, a vacuum pump (which is not shown in the drawing) adapted to vacuum a vacuum chamber 34, and a heat sealing part 50 for sealing the opening portion of the plastic bag 21.

In case of vacuum sealing the plastic bag 21 by using the conventional apparatus 20, articles like foods are first placed into an appropriate location on the inside of the plastic bag, and the opening portion of the plastic bag 21 is located on the interior of the vacuum chamber 34. Next, the hood 33 is descended above the base 32, such that the plastic bag 21 and the vacuum chamber 34 are all closed. If a predetermined switch is manipulated to operate the vacuum pump, then, the vacuum chamber 34 gets vacuumed by the operation of the vacuum pump, which enables the air in the interior of the plastic bag 21 to be removed therefrom. Finally, the opening portion of the plastic bag 21 is heat sealed by means of the heat sealing part 50. At that time, the formation of the embossing part 25 on one inside of the plastic bag 21, as shown in FIG 1a, allows the air filled in the interior of the plastic bag 21 to be absorbed and removed.

However, the conventional chamber type apparatus for vacuum sealing the plastic bag needs the embossing part that is fabricated at a high cost. In addition, the embossing part may be broken by means of a pair of rollers that have been heated during its manufacturing process, which makes the number of bad plastic bags substantially increase.

On the other hand, there is another conventional apparatus for vacuum sealing the plastic bag that is employed with a nozzle. In this case, the nozzle is inserted in the interior of the plastic bag at the time of providing vacuum to the plastic bag and after the vacuuming procedure is completed, it should be separated from the plastic bag. At that time, however, a number of complicated devices for controlling the position of the nozzle are needed during the vacuum sealing procedure and during the heat sealing.

There is still another conventional apparatus for vacuum sealing the plastic bag, wherein the portion of the plastic bag that is located on the front of the nozzle is heat sealed, but in this case, the nozzle is placed on the opening portion of the plastic bag such that local air traps may be formed, which of course makes it difficult to seal the plastic bag well. Moreover, there occurs a problem that the length of the plastic bag corresponding to the depth of the nozzle inserted in the interior of the plastic bag is consumed unnecessarily.

### DISCLOSURE OF THE INVENTION

Therefore, the present invention has been made in view of the above-described problems and it is an object of the present invention to provide a nozzle for vacuum sealing a plastic bag that is inserted and heat sealed together with the plastic bag, without any formation of an embossing part on the inside of the plastic bag.

It is another object of the present invention is to provide a nozzle for vacuum sealing a plastic bag that is heat sealed together with the opening portion of the plastic bag after a vacuuming procedure.

It is still another object of the present invention is to provide a nozzle for vacuum sealing a plastic bag that does not generate local air traps, thereby achieving a substantially rapid vacuuming procedure.

It is still yet another object of the present invention is to provide a nozzle for vacuum sealing a plastic bag that is provided with a plurality of break lines thereon, thereby being cut to a predetermined desired length, without any unnecessary consumption.

To accomplish the above objects, according to the present invention, there is provided a nozzle for vacuum sealing a plastic bag, the nozzle including: an embossing part formed on the peripheral surface of the nozzle, so that air discharging passages are formed on the peripheral surface of the nozzle; and a plurality of break lines formed at predetermined regular intervals on the outer peripheral surface of the nozzle, for cutting the nozzle to a predetermined length, wherein the nozzle is made of a heat sealable material, so that the nozzle cut by the break line is inserted into the plastic bag and heat sealed together with the plastic bag.

Preferably, the nozzle has a plurality of through holes that are formed on the outer peripheral surface thereof, thereby preventing the generation of local air traps and allowing a vacuuming procedure to be achieved at a substantially rapid speed. Also, the embossing part is in the form of continuous channels or dispersed protruding objects, on the inner or outer peripheral surface of the nozzle.

### BRIEF DESCRIPTION OF THE DRAWINGS

Further objects and advantages of the invention can be more fully understood from the following detailed description taken in conjunction with the accompanying drawings, in which:

FIG 1a is a perspective view showing a conventional plastic bag on which an embossing part is formed on the inside thereof;

FIG 1b is a perspective view showing the sealing method embodied with the conventional plastic bag with the embossing part on the inside thereof;

FIG. 2 is a plan view showing a nozzle for vacuum sealing a plastic bag according to the present invention;

FIG. 3 is an enlarged perspective view showing a part of the nozzle of this invention;

FIG. 4 is an enlarged sectional view taken along the line A-A of FIG. 3;

FIG. 5 is a perspective view showing the nozzle of this invention employed in a vacuum sealing apparatus; and

FIG. 6 is a perspective view showing the nozzle of this invention that is heat sealed together with the plastic bag.

### BEST MODE FOR CARRYING OUT THE INVENTION

Now, an explanation of the preferred embodiment of the present invention will be given hereinafter.

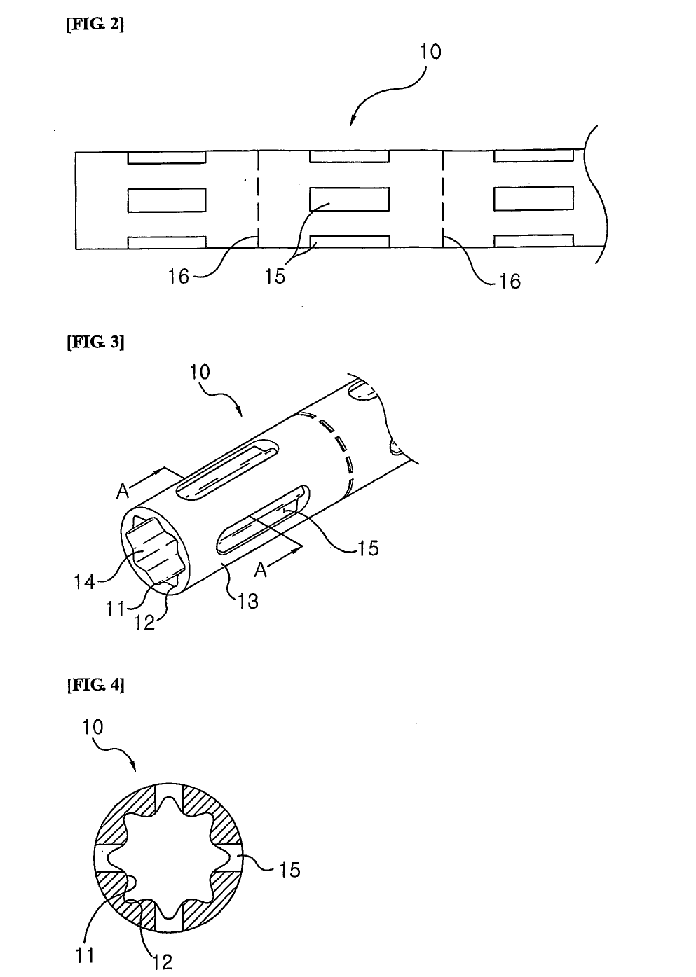

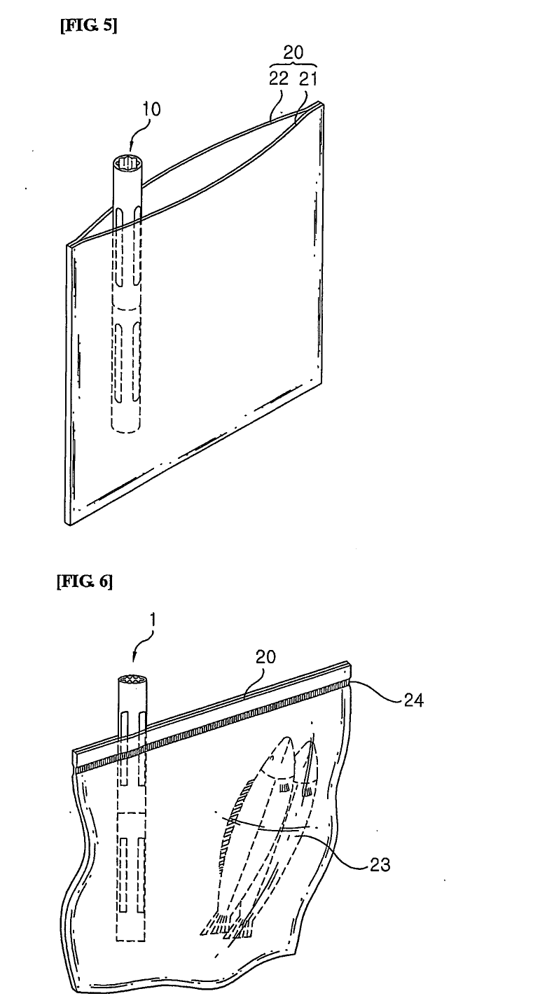

FIGS. 2 to 4 show a nozzle 10 for vacuum sealing a plastic bag according to the present invention. The nozzle 10 of this invention includes an embossing part 11 and a plurality of break lines 16 and is made of a heat sealable material in such a manner as to be inserted into the plastic bag 20 (see FIG. 6), thereby providing air discharging passages 12 from the plastic bag 20. After this vacuuming step, the nozzle 10 is heat sealed together with the plastic bag 20 by the operation of a heat sealing part 24.

The nozzle 10 is sufficiently long but it is easily cut on the break lines 16 as will be discussed later, if necessary.

The embossing part 11 is of a concave/convex shape on the inner peripheral surface 14 of the nozzle 10, such that the air discharging passages 12 are continuously formed along the length direction of the nozzle 10. On the other hand, the embossing part 11 may be formed on the outer peripheral surface 13 of the nozzle 10 or be formed both on the inner or outer peripheral surface 14 or 13. Further, the embossing part 11 may be in the form of dispersed protruding objects or may be in the form of grooves. With the embossing part 11, in case where the nozzle 10 is inserted into the plastic bag 20 and then compressed by the external force like a packing part of a vacuum sealing apparatus (not shown), the air discharging passages 12 are maintained thus to extract the air in the plastic bag 20 therefrom.

The plurality of break lines 16 are located on the outer peripheral surface of the nozzle 10, permitting the nozzle 10 to be easily cut when necessary. So, the length of the nozzle 10 is adjustable depending upon the size of the plastic bag 20. Thus, the nozzle 10 is supplied in a sufficiently long length like a roll of a nozzle, and if necessary, it is easily cut on a predetermined break line thereof. Desirably, the break lines 16 are in the shape of a broken line or are cut by about half thickness of the nozzle 10.

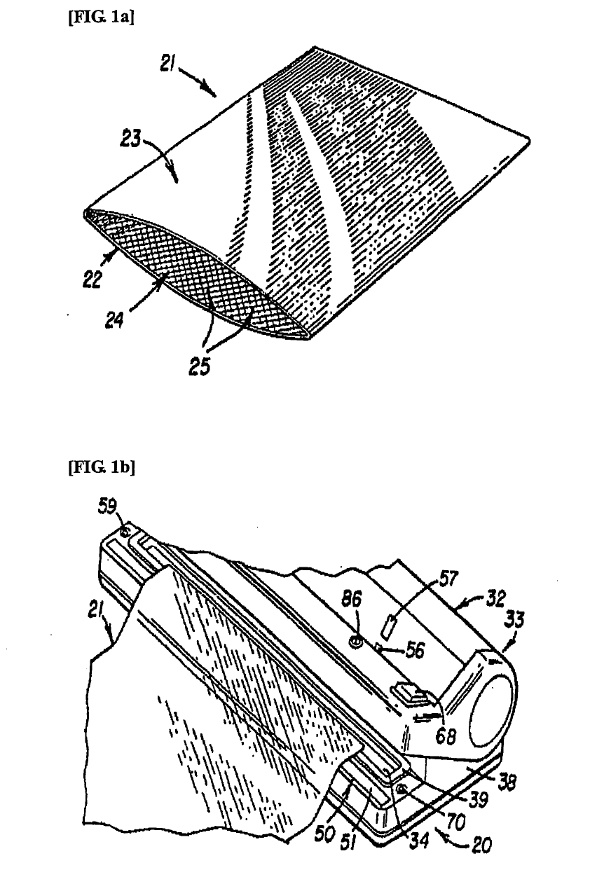

The nozzle 10 is made of a heat sealable material such as polyethylene, a high density of polyethylene, polypropylene and so on, and has a thickness (excluding the size of the embossing part) of tens of μm, which is appropriately the same as the plastic bag 20, so that it can be easily sealed together with the plastic bag 20 in the state of being inserted into the plastic bag 20. Thus, the nozzle 10 of this invention can be applied to both the chamber type vacuum sealing apparatus (see FIG. 1b) and the nozzle type vacuum sealing apparatus (not shown). At this time, in case of the nozzle type vacuum sealing apparatus, the nozzle 10 of this invention is adapted to be mounted on the nozzle in the apparatus in order to provide the air discharging passages from the plastic bag, such that the plastic bag 20 is vacuumed and heat sealed.

On the other hand, the nozzle 10 is provided with a plurality of through holes 15 on the outer peripheral surface thereof, for the purpose of rapidly discharging the internal air of the plastic bag 20 and preventing the generation of local air traps. The plurality of through holes 15 are elongated slots through which the air flow occurs and they are located on the outer peripheral surface of the nozzle 10

As shown in FIGS. 5 and 6, the nozzle 10 of this invention is inserted into the plastic bag 20. The plastic bag 20 includes an upper panel 21 and a lower panel 22 and is formed of a heat sealable material.

The articles 23 like foods for storage are placed into the plastic bag 20, and the nozzle 10 of this invention is inserted into the plastic bag 20. After that, the plastic bag 20 is placed at a predetermined location of the vacuum sealing apparatus as shown in FIG. 1b, and as the hood of the apparatus is closed, the opening portion of the plastic bag 20 becomes closed. In this case, however, the air discharging passages 12 by the formation of the embossing part 11 of the nozzle 10 of this invention are maintained such that the air in the plastic bag 20 is completely removed. After the vacuuming step, the opening portion of the plastic bag 20 is heat sealed together with the nozzle 10 by the operation of the heat sealing part 24, thereby completing the vacuum sealing procedure.

### INDUSTRIAL APPLICABILITY

As set forth in the foregoing, the nozzle of this invention can be provided at a substantially low cost and at a high efficiency, without any formation of an embossing part on the inside of the plastic bag.

In addition, the nozzle of this invention can be heat sealed together with the opening portion of the plastic bag after the completion of the vacuuming procedure, thereby making it convenient to use.

The nozzle of this invention can be heat sealed together with the opening portion of the plastic bag after the completion of the vacuuming procedure, such that it can be applied to both a chamber type vacuum sealing apparatus and a nozzle type vacuum sealing apparatus.

Also, the nozzle of this invention can be provided with the plurality of through holes, so that the generation of local air traps can be prevented and the vacuuming step can be achieved at a substantially fast speed.

The nozzle of this invention can be provided with the plurality of break lines, so that it is supplied as a roll of a nozzle and is cut to a predetermined desired length, without any unnecessary consumption.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

1. A nozzle for vacuum sealing a plastic bag, the nozzle comprising:
an embossing part formed on the peripheral surface of the nozzle, so that air discharging passages are formed on the peripheral surface of the nozzle; and
a plurality of break lines formed at predetermined regular intervals on the outer peripheral surface of the nozzle, for cutting the nozzle to a predetermined length, wherein the nozzle is made of a heat sealable material, so that the nozzle cut by the break line is inserted into the plastic bag and heat sealed together with the plastic bag.

2. The nozzle according to claim 1, wherein the nozzle has a plurality of through holes formed on the outer peripheral surface thereof.

3. The nozzle according to claim 1, wherein the embossing part is formed on the inner peripheral surface of the nozzle.

4. The nozzle according to claim 2, wherein the embossing part is formed on the inner peripheral surface of the nozzle.
